(19) United States
(12) Patent Application Publication
(10) Pub. No.: US 2004/0161197 A1
(43) Pub. Date: Aug. 19, 2004

(54) Adjustable chromatic dispersion compensator

(75) Inventors: Francois Pelletier, Saint-Augustin-De-Desmaures (CA); Andre Vo Van, Quebec (CA)

Correspondence Address: DARBY & DARBY P.C., P. O. BOX 5257, NEW YORK, NY, 10150-5257, US

(73) Assignee: Teraxion Inc., Sainte-Foy (CA)

(21) Appl. No.: 10/773,005

(22) Filed: Feb. 4, 2004

(30) Foreign Application Priority Data
Feb. 4, 2003 (CA) 2,418,382

(51) Int. Cl. G02B 6/34

(52) U.S. Cl. 385/37; 385/13

(57) ABSTRACT

An adjustable chromatic dispersion compensator is provided, with the possibility of passive athermalisation. The device includes an optical fiber grating which is fixed on its length to an elongated beam member that has a flexible cantilever portion so that a non-uniform tensile strain induced in the grating reconfigures the group delay response. The chirp of the grating is changed by the bending of the bar, allowing adjustable chromatic dispersion compensation. Adjustment of the central filter wavelength without affecting the grating integrity is further provided. A multi-material construction allows the package to passively compensate for the natural temperature dependence of the filter resonance wavelength by varying the strain in the fiber in response to changes in the ambient temperature.

### FIELD OF THE INVENTION

The present invention relates to the compensation of chromatic dispersion, occurring in waveguides such as optical fibers. More specifically, the invention concerns a Bragg grating-based chromatic dispersion compensator which allows an adjustment of the dispersion profile while maintaining the value of the Bragg wavelength. In preferred embodiments, the present invention also provides the athermalisation of the dispersion compensator.

### BACKGROUND OF THE INVENTION

In optical telecommunication systems, one of the difficulties encountered is the chromatic dispersion of light signals propagating over long distances in optical media such as optical fibers. Chromatic dispersion causes light pulses to spread out as they travel along an optical fiber. It occurs because the different spectral components at different wavelengths in a pulse travel at slightly different speeds. An optical pulse, which comprises different optical spectral components, therefore, can be broadened or distorted in shape after propagation through a distance in such a dispersive optical medium. This dispersion effect can be undesirable and even adverse for certain applications such as optical communication systems where information is encoded, processed, and transmitted through optical pulses. As the pulses spread, they can overlap and interfere with each other, thereby impacting signal integrity and limiting the transmission bit rate, the transmission bandwidth, and other performance factors of the optical communication systems. The effect becomes more pronounced at higher data rates. Pulses at different wavelengths typically suffer different amounts of dispersion. The chromatic dispersion in standard single-mode optical fiber is nominally 17 ps/(nm·km) in the 1550 nm telecommunication window, but this value changes as a function of the wavelength: it changes by about 2 ps/(nm·km) between 1530 nm and 1565 nm.

One way to mitigate the chromatic dispersion in dispersive optical fibers and other optical transmission media is to recompress the optical pulses using an optical element that provides dispersion that is just the opposite of the one of the fiber link. This process is referred to as dispersion compensation.

A known method to compensate for chromatic dispersion is based on Fiber Bragg gratings (FBGs), a well-established technology for optical tele-communications. A fiber Bragg grating consists of a periodic modulation of the refractive index along the core of an optical fiber. It is created by exposing a photosensitive fiber to a properly shaped intensity pattern of ultraviolet light. This light produces a permanent change of the refractive index in selected sections of the optical fiber. The resulting optical fiber grating thus behaves as a wavelength-selective reflector having a reflectance spectral curve with at least one well-defined peak. The reflected wavelength of light is often referred to as the grating wavelength or as the Bragg wavelength of the grating. A chirped FBG, in which the grating period varies along the fiber axis, represents a well-known solution for compensating the chromatic dispersion of an optical fiber link (Ouellette, 1987). Such a grating compensates for the accumulated dispersion since the group delay varies as a function of the wavelength. An appropriate grating can be fabricated such that the wavelength dependence of its group delay is just the opposite of that of the fiber link.

Critical factors that affect dispersion compensation at high bit rate are changing traffic patterns, temperature fluctuations along the fiber, modulation format, component dispersion levels and dispersion variations in the transmission fiber (from manufacturing variances). When considering 10 Gb/s systems, adjustability of the chromatic dispersion level is desirable at the customer site, mainly for inventory reasons (system reconfigurations). For 40 Gb/s systems, tunability, rather than adjustability, is required to adjust the dispersion compensation in real-time for different DWDM (Dense Wavelength-Division-Multiplexing) channels. Tunability is usually accomplished using active components. Adjustability, on the other hand, can be passively achieved with numerous techniques such as mechanically stretching FBGs, for which different approaches are known. The fiber may be stretched either uniformly or non-uniformly, by two attached points at each extremity or by a continuous securing of the fiber along the length of the grating.

Attempts have been made to use magnetostrictive strain for tuning the fiber grating (U.S. Pat. No. 5,812,711 (GLASS et al.) and U.S. Pat. No. 6,122,421 (ADAMS et al.)). The disadvantages of this approach are that the size of magnetostrictive component is large and the cost of the device is relatively high.

G. A. Ball and W. W. Morey, used a compression-tuned approach to tune fiber Bragg gratings over 32 nm ranges (see Ball and Morey, “Compression-tuned single-frequency Bragg grating fiber laser”, Optics Letters, Vol. 19, No. 23, 1994, pp. 1979). This approach needs very precisely grounded ceramic ferrules, and very high accurate alignment and is very expensive.

Different magnets arrangements have also been used for uniformly stretching FBGs by inducing longitudinal strain in latchable bistable systems (see for example U.S. Pat. No. 6,055,348 (JIN et al.) , and U.S. Pat. No. 6,154,590 (JIN et al.).

Chirp tuning for dispersion compensation purposes, is also realised by inducing a bending strain in a FBG. A strain gradient is obtained by fixing the FBG on top of a beam having a constant or varying cross-section, and by putting that beam in bending. Hill & Eggleton (P. C. Hill and B. J Eggleton, “Strain gradient chirp of fibre Bragg gratings,” Electron. Lett., 30, 1994, pp. 1172-1174) describe the use of a linear strain gradient applied to a uniformly chirped FBG, but the disclosed method is not easily applicable. Garthe et al. (Garthe et al., “Adjustable Dispersion Equaliser for 10 and 20 Gbit/s Over Distances Up to 160 km”, Electr. Lett. Vol. 30, No. 25, 1994, 2159-2160), as for them, have shown that deflection of a beam with constant width and thickness, which is fixed at one of its ends, could convert a mounted uniform FBG into a linearly chirped FBG due to the induced linear strain gradient on the surface of the beam. U.S. Pat. No. 6,360,042 (LONG) discloses the use of the bending of a long period FBG to tune wavelength. Goh et al. (C. S. Goh, S. Y. Set, K. Taira, S. K. Khywania and K. Kikuchi, “Nonlinearly Strain-Chirped Fiber Bragg Grating With an Adjustable Dispersion Slope,” IEEE Photon. Tech. Lett., 14, 2002, pp. 663-665) apply a nonlinear strain gradient to a uniform FBG.

The main drawback of these approaches is the resulting variation of the characteristic wavelength λ_{c} of the FBG as the compensation level is tuned. To minimise that wavelength change, solutions have been proposed in which the bending of the beam was carried out differently (T. Imai, T. Komukai, and M. Nakazawa “Dispersion Tuning Of A Linearly Chirped Fiber Bragg Grating Without a Center Wavelength Shift By Applying a Strain Gradient”, IEEE Photon. Tech. Lett., Vol. 10, No. 6, June 1998, pp. 845-847), or in which a simply-supported beam was used rather than a cantilever beam (Y. Liu, X Dong and J. Yang, “Tunable chirping of a fiber Bragg grating without center wavelength shift using a simply supported beam,” Opt Eng., 41, 2002, pp. 740-741). Most of these solutions rely on the fact that a beam in bending always has a “neutral axis” along which the strain is zero. By having the center of the FBG going through that neutral axis, it is in theory possible to adjust the compensation level while minimising the change in central wavelength of the FBG. Finally, recent results show an adjustable dispersion compensator with a fixed central wavelength and fixed bandwidth, using a novel bending technique (Y. W Song, D. Starodubov, Z. Pan, Y. Xie, A. E. Willner and J. Feinberg, “Tunable WDM Dispersion Compensation With Fixed Bandwidth and Fixed Passband Center Wavelength Using a Uniform FBG,” IEEE Photon. Technol. Lett., 14, 1193-1195 (2002)).

All these solutions, while allowing adjustable compensation of the chromatic dispersion, have drawbacks that render them difficult to implement in a practical setting. In addition, they fail to address one major issue related to passive FBG components: athermalisation. The Bragg wavelength depends on the period of modulation and on the average value of the refractive index of the fiber. Both quantities vary nearly linearly with the ambient temperature and the stress applied to the fiber. This, in turn, translates into a nearly linear variation of the Bragg wavelength with temperature and stress. For example, the Bragg wavelength of a typical FBG increases with temperature at a rate of about 10 pm/° C. As a result, fiber Bragg gratings are well suited for use as strain or temperature sensors. The thermal dependence, on the other hand, represents a major disadvantage for applications requiring a good stability of the spectral response of the FBG. It prevents the use of FBGs in advanced communication networks and in commercial systems, which typically have to operate over an extensive range of temperatures (the “outside plant” standard in the U.S. is −40 to +85° C.). For the accurate and reliable long-term operation of these devices, suitable temperature compensation techniques are required.

Different temperature stabilisation techniques have been proposed in the past, and there are already many known various types of packages for holding Bragg gratings constructed so as to render the Bragg wavelength insensitive to temperature changes.

A first class of athermal systems relies on the active stabilisation of the FBG spectral response. Certain parameters are continuously monitored and dynamically controlled with a feedback loop. For example, active temperature control of the grating environment is typically accomplished by a stabilisation system that holds the temperature at a level above the maximum ambient temperature to which the device is expected to be exposed. The temperature control can be carried out with devices such as Peltier elements. In other systems, the Bragg wavelength is monitored continuously and corrected by straining the fiber with piezoelectric elements. While being an effective approach, active thermal stabilisation is costly to implement, its complexity leads to reliability concerns, and the power consumption of control circuits represents a major drawback. In general, preference is given to so-called passive devices, since they are much simpler and require no power source.

Passive temperature compensation devices generally operate by controlling the elongation with temperature of the optical fiber containing the FBG. This is usually accomplished by clamping the fiber containing the FBG to a mechanical structure that imposes a negative elongation to the fiber as the temperature increases. This contraction of the fiber compensates for the increase of its refractive index with temperature, thus allowing a stabilisation of its Bragg wavelength against temperature fluctuations. Examples of such devices, using certain glass-ceramics as the support material, are described for example by D. L. Weidman in D. L. Weidman, G. H. Beall, K. C. Chyung, G. L. FranciS, R. A. Modavis, and R. M. Morena, “A novel negative expansion substrate material for athermalising fiber Bragg gratings”, 22nd European Conference on Optical Communication—ECOC'96, Oslo, Paper MoB 3.5, pp. 1-61..63, in U.S. Pat. No. 5,694,503 (FLEMING), and in U.S. Pat. No. 6,087,280 (BEALL et al.). While conceptually being the simplest method to achieve thermal compensation, these methods suffer from major drawbacks, among others, the difficulty to precisely match the coefficient of thermal expansion of the fiber, and, also, the presence of significant hysteresis phenomena. Moreover, this approach is not well suited to compensate for an adjustable chromatic dispersion compensation device.

Such passive temperature compensation can also be achieved through the principle of differential expansion. The fiber containing the FBG is clamped to a structure made of materials having different, but usually positive, coefficients of thermal expansion (CTE). The structure is arranged such that the different rates of expansion between the structural elements supporting the fiber result in a negative elongation of the fiber with an increase of the temperature. Typically, the fiber is stretched at low temperatures and allowed to relax as the temperature increases.

Many devices that employ materials with dissimilar positive thermal expansions to achieve the required negative expansion are known. An example of typical prior art of passive temperature-compensating package is, for example, U.S. Pat. No. 4,936,664 (ENOCH et al.) disclosing relatively temperature insensitive fiber Bragg gratings. This is one of the earliest references describing an athermal package for optical fibers. U.S. Pat. No. 5,042,898 (MOREY et al.) discloses a similar idea, associating aluminum as the material having the greater coefficient of expansion with Invar, silica, stainless steel, or iron as the material having the smaller coefficient of expansion. G. W. Yoffe (in G. W Yoffe, P. A. Krug, F. Ouellette, and D. A. Thorncraft, “Passive temperature-compensating package for optical fiber gratings”, Appl. Optics, Vol. 34, No. 30, October 1995, pp. 6859-6861) discloses one of the first practical devices for packaging Bragg gratings. This paper also describes an active strain adjustment to set the strain of the fiber to the desired initial value. T. E. Hammon (T. E. Hammon, J. Bulman, F. Ouellette, and S. B. Poole, “A temperature compensated optical fiber Bragg grating band rejection filter and wavelength reference”, OECC '98 Technical Digest, pp. 350-351, 1996) similarly presents packaging structures using a combination of two different materials having different thermal expansion coefficients.

In view of the above, there is a need for a novel design for an adjustable dispersion compensator with dispersion compensation profile adjustability, preferably passively athermal, that would overcome the drawbacks of the prior art devices.

### SUMMARY OF THE INVENTION

Accordingly, it is an object of the present invention to provide a FBG-based chromatic dispersion compensator for which the dispersion compensation profile and the characteristic wavelength of the grating may both be independently adjusted.

It is a preferable object of the invention to provide such a dispersion compensator which is insensitive to temperature variations.

Another preferable object of the invention is to provide such a device which, once set, does not require any energy input to maintain its settings.

It is another object of the invention to provide an adjustment assembly for packaging a dispersion compensator as mentioned above.

It is yet another object of the invention to provide a method for adjusting the dispersion compensation profile of a dispersion compensator while maintaining its characteristic wavelength.

In accordance with the above objects, the present invention therefore provides an adjustable chromatic dispersion compensator, which includes a length of optical fiber which has an optical grating region. In this region is provided a Fiber Bragg Grating (FBG) having a characteristic wavelength and a dispersion compensation profile.

The compensator also includes an elongated beam member having a longitudinal neutral axis and a cantilever portion. It also includes securing means for continuously securing the optical grating region along the cantilever portion in a fixed relationship with this neutral axis. Bending means are provided for bending the cantilever portion, to generate a strain gradient along the FBG. The strain gradient adjusts the dispersion compensation profile and shifts the characteristic wavelength of the FBG. Compressing means are additionally provided for compressing the cantilever portion longitudinally to generate a linear strain in the FBG. The linear strain rectifies the characteristic wavelength of the FBG.

Preferably, the dispersion compensator is rendered athermal in a passive manner. In accordance with a preferred embodiment of the invention, a hollow member having opposed ends and longitudinally receiving the beam member therein is provided, and a compression screw projects longitudinally inside this hollow member to exert a longitudinal pressure on the beam member from one of the opposed ends of the hollow member. A restraining element longitudinally restrains the beam member at the other one of the opposed ends. Athermality is achieved by providing an athermalising insert inside the hollow member between the compression screw and the beam member, and selecting the coefficient of thermal expansion (CTE) of each of the hollow member, compression screw, athermalising insert and beam member so that they together compensate for effects of temperature variations on the characteristic wavelength of the FBG.

In accordance with another object of the present invention, there is also provided an adjustment assembly for a chromatic dispersion device, the compensator including a length of optical fiber having an optical grating region and a Fiber Bragg Grating (FBG) provided in this optical grating region. The FBG has a characteristic wavelength and a dispersion compensation profile.

The adjustment assembly first includes an elongated beam member, having a longitudinal neutral axis and a cantilever portion. Securing means are also provided for continuously securing the optical grating region along the cantilever portion in a fixed relationship with the neutral axis. The assembly further includes bending means for bending the cantilever portion to generate a strain gradient along the FBG, the strain gradient adjusting the dispersion compensation profile and shifting the characteristic wavelength. Finally compressing means are provided for compressing the cantilever portion longitudinally to generate a linear strain in the FBG, the linear strain rectifying the characteristic wavelength.

In accordance with yet another aspect of the present invention, there is also provided a method for adjusting the dispersion compensation profile of a chromatic dispersion compensator, this chromatic dispersion compensator including a length of optical fiber having an optical grating region and a Fiber Bragg Grating (FBG) provided in this optical grating region, the FBG having a characteristic wavelength.

The method includes the following steps:

a) continuously securing the optical grating region along the cantilever portion of an elongated beam member, in a fixed relationship with a neutral axis extending longitudinally through this beam member;

b) bending the cantilever portion to generate a strain gradient along the FBG, the strain gradient adjusting the dispersion compensation profile and shifting the characteristic wavelength of the FBG; and

c) compressing the cantilever portion longitudinally to generate a linear strain in the FBG, this linear strain rectifying the characteristic wavelength.

According to an exemplary embodiment of the present invention, adjustability of the chromatic dispersion compensation is achieved by fixing a linearly chirped FBG on top of a constant cross-section cantilever. Bending is applied laterally to the cantilever to vary the strain gradient transmitted to the FBG. Precise control of the dispersion compensation profile is achieved by using an appropriate beam cross-section. Bending can occur in both directions, allowing to either increase or decrease the FBG dispersion compensation profile around its initial value. Adjustability of the characteristic wavelength is achieved by applying a compression along the longitudinal axis of the device. By changing the compression level of the cantilever (and hence its length), the compression mechanism allows for adjustability of the characteristic wavelength of the FBG. Because the linear strain applied via the compression mechanism is additive to the strain gradient imposed by the bending of the beam (see F. P. Beer and E. R. Johnston, Mechanics of Materials, Second ed. McGraw-Hill, (1992)), the characteristic wavelength adjustment is independent of the dispersion compensation profile adjustment. Although not valid with large bending displacements, the adjustment does not affect the chromatic dispersion compensation profile with small bending amplitude. This implies that the cantilever beam must be fairly rigid, rigidity being proportional to Young's Modulus of the beam material multiplied by the beam inertia, to generate high strains without generating much displacement.

Still referring to preferred features of the invention, while characteristic wavelength and dispersion profile adjustments are user controlled, athermalisation of the device is done passively. The mechanism uses the same theory as the wavelength adjustment, and is achieved by using a low coefficient of thermal expansion (CTE) material for the cantilever beam and an insert made of a high CTE material placed between the compression mechanism and the beam. As temperature fluctuates, the overall assembly changes in length, thus modifying the compression in the beam as the compression mechanism would. Proper material and insert length selection allows for adequate compensation of the characteristic wavelength drift, thereby making the device athermal.

Other features and advantages of the present invention will be better understood upon reading of preferred embodiments thereof with reference to the appended drawings.

### BRIEF DESCRIPTION OF THE DRAWINGS

FIG. 1 is a schematic side view of an adjustable passive athermal chromatic dispersion compensator according to a preferred embodiment of the present invention.

FIG. 2 is a schematic representation of a strain distribution for wavelength adjustment and for chromatic dispersion adjustment.

FIG. 3 is a graph showing experimental results of chromatic dispersion tuning with characteristic wavelength correction on ITU grid.

FIG. 4 is a graph showing experimental results of characteristic wavelength shift as a function of temperature.

### DESCRIPTION OF PREFERRED EMBODIMENTS OF THE INVENTION

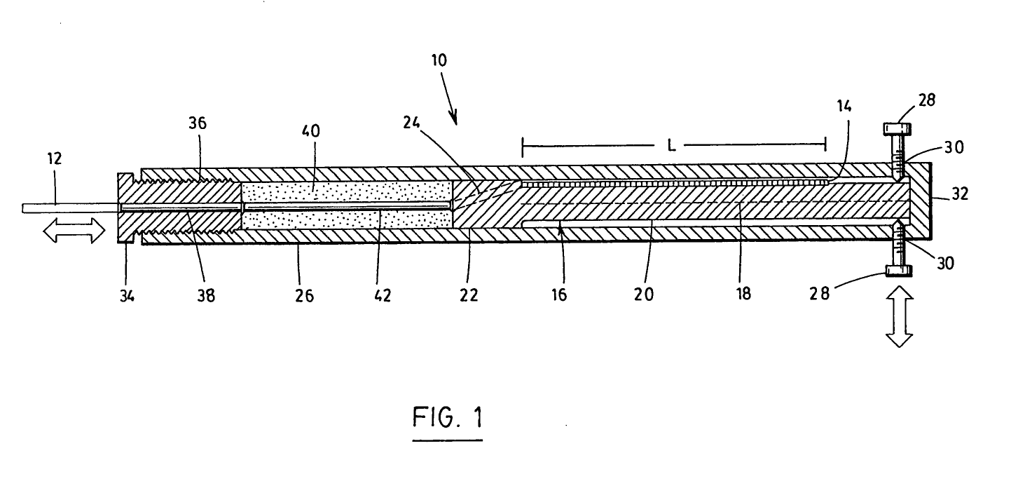

Referring to FIG. 1, there is shown an adjustable chromatic dispersion compensator 10 according to a preferred embodiment of the present invention. A length of optical fiber 12 supports a fiber Bragg grating (FBG) along an optical grating region 14. The FBG has a desired Bragg reflection wavelength, the characteristic wavelength, and has a dispersion compensation profile preferably defined by a linear chirp in the grating, used to compensate dispersion in a specific channel of a DWDM (Dense Wavelength-Division-Multiplexing) or other communication system. The length of the grating that can be used in the present compensator is typically in the range of 5 mm to 150 mm. In another preferred embodiment, the optical fiber 12 may support a superimposition of a plurality of gratings in the same optical grating region 14, instead of a single FBG, thereby simultaneously tuning the chromatic dispersion of a plurality of channels.

The compensator 10 includes an elongated beam member 16 having a longitudinal neutral axis 18 (as commonly defined in structural analysis) and preferably provided with an anchor portion 22 and a cantilever portion 20 which can be bent with respect to the anchor portion 22. The optical grating region 14 of the optical fiber 12 is secured along the cantilever portion 20 in a fixed relationship with the neutral axis 18, that is, at an unchanging distance therefrom. Advantageously they are in parallel and the optical fiber 12 is secured to the surface of the cantilever portion 20. Appropriate measures are taken so that the optical grating region 14 is secured along its entire length L to the cantilever portion 20, preferably glue or an epoxy type of material, as well as soldering of a metalized fiber to the cantilever portion 20 or even a metallic elongated tube (not shown) perfectly receiving the grating region 14 of the fiber 12 disposed along the cantilever portion 20 and fixed thereto by welding, soldering or crimping or any other means that can transmit a bend from the cantilever portion 20 to the optical grating region 14, without sliding motion of one relative to the other along the length of the cantilever portion 20. The cantilever portion 20 may be provided with a fiber-guiding area receiving the grating region 14 of the fiber 12 preferably in the form of a groove extending therealong. Preferably, the optical fiber 12 also extends through a hollow path 24 drilled into the anchor portion 22 of the beam member 16.

The compensator 10 preferably includes a hollow member 26, preferably in the form of a longitudinal tube, longitudinally receiving the beam member 16 therein. The anchor portion 22 of the beam member 16 snugly fits the interior diameter of the hollow member 26, and can therefore move therein longitudinally only. In accordance with an aspect of the present invention, the cantilever portion 20 may be to generate a strain gradient in the FBG. This is preferably achieved by using a cantilever portion 20 having a uniform cross-section along the fiber grating region 14, making the local bending angle continuously increasing between the two ends of the grating. Advantageously, one of the extremities of the FBG is precisely adjusted on the cantilever portion 20 so that it is in alignment with the origin of the reference plane (x=0) corresponding to the point where the cantilever and anchor portions meet, in order to minimise the required force to generate the appropriate strain in the grating.

In the preferred embodiment of the invention illustrated in FIG. 1, the cantilever portion 20 is bent to the appropriate stress level by a pair of opposite lateral screws 28 facing each other and contacting the cantilever portion 20 of the beam member 16. Corresponding threaded cavities 30 are also provided on opposite sides of the hollow member 26. In this case, loosening one screw and tightening the other in sequence will induce the transversal displacement of the cantilever portion 20. Once the desired tuning of the grating is achieved, the bent position of the cantilever portion 20 is secured by tightening both screws 28. Since they are facing each other, proper tightening will make for an equilibrated and solid tension. Alternatively, The beam flexion could also be induced by other mechanical means such as a motor-driven force, pneumatic force, actuated weight, or hydraulic pressure, to a desired extent, and mechanically latched with, for example, a solenoid or a stepper motor. Even a manual actuation or any other appropriate means could also be envisaged.

It will be readily understood by one skilled in the art that the strain gradient generated in the FBG will have the effect of adjusting the dispersion compensation profile thereof. If the grating is linearly chirped, the value of the chirp will be modified. If the grating has no chirp, it will induce one. By bending the cantilever to the correct strain, the grating group delay is therefore changed and the level of chromatic dispersion compensation is thus adjusted to the desired value. It will also have the effect of shifting the characteristic wavelength of the grating. This last effect is usually unwelcome, as the characteristic wavelength needs to be maintained at a precise value for the device to be usable within DWDM systems. Current telecommunications applications require accuracy of the order of a few tens of picometers on the Bragg wavelength of FBGs. This requires a submicron-level control of the length of the gratings. The ingenious manner in which the present invention solves this problem will become apparent hereinbelow.

The dispersion compensator 10 according to the present invention further includes means for compressing the cantilever portion 20 longitudinally. Preferably, a pressure exerting mechanism exerting a longitudinal pressure on the beam member 16 inside the hollow member 26 from one of its ends, and a restraining element longitudinally restrains the beam member 16 at the other end of the hollow member. In the illustrated embodiment, the restraining element is a transversal wall 32 integral to the hollow member 26 at its extremity, but could also be a plug type device inserted in the hollow member 26 or any other manner of axially restraining the movement of the beam member 16. In the embodiment of FIG. 1, the pressure exerting mechanism is a compression screw 34 projecting longitudinally inside the hollow member 26 and cooperating with the threads 36 therein. Rotating the compression screw 34 slightly compacts the beam member 16, thereby modifying the length of the grating. Advantageously, the compression screw 34 is provided with fine pitch threads, and a cavity 38 extends along its core for receiving the optical fiber 12 therethrough, preferably in a co-centered relationship. Other manners of exerting pressure on the beam member 16 could equally be devised without departing from the scope of the present invention.

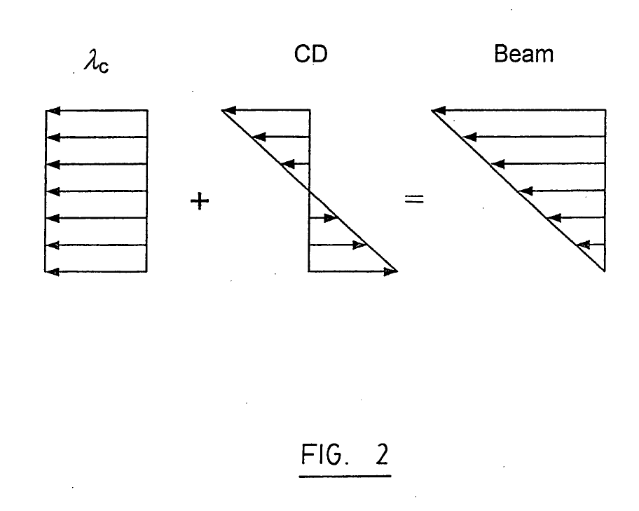

The compression of the beam member 16 and therefore of its cantilever portion 20 has the effect of generating a linear strain in the optical grating region 14 of the fiber 12 which is opposite to the strain gradient resulting from bending the cantilever portion 20. The compression strain being linear it will not have any significant effect on the dispersion compensation profile of the FBG, which remains unchanged. It will however rectify the characteristic wavelength of the grating, and by proper selection of all the parameters of the device may cancel the effect of the bending thereon or set it to another desired value, In this manner, the dispersion compensation profile and characteristic wavelength of the compensator 10 may be independently adjusted, alleviating an important drawback of many prior art systems. The individual and combined effect of the bending and compressing of the cantilever beam on the strain distribution in the FBG is shematized in FIG. 2.

Still referring to FIG. 1, in accordance with another advantageous feature of the present embodiment, the dispersion compensator 10 of the present invention is rendered passively athermal. This is primarily achieved by providing an athermalising insert 40 inside the hollow member 26 between the compression screw 34 and the beam member 16. A cavity 42 is provided through this insert 40 to allow the optical fiber 12 therethrough, preferably in a co-centered relationship. The hollow member 26, compression screw 34 and beam member 16 are preferably made of a material with a small coefficient of thermal expansion (CTE), while the athermalising insert 40 is made of a material with a sizeably larger CTE. In the preferred embodiment of the invention, the hollow member 26, compression screw 34 and beam member 16 are all made out of invar, and the expansion member 20 is made out of aluminum. These materials are commercially available, inexpensive, and easy to machine. The combined thermal expansions of the hollow member 26, the athermalising insert 40, and the compression screw 34 result in a negative CTE characterising the thermal variation of the fixed length of the grating. This therefore compensates for the thermal variations of the refractive index of the grating, and then stabilises the Bragg wavelength of the latter against temperature fluctuations

Although the description above has been directed to a chromatic dispersion compensator, it is understood that the present invention could equally be applied to any FBG or superposition of FBGs having a grating profile which needs to be adjusted. The principles of the present invention may be used to provide an adjustable assembly for any such type of chromatic dispersion device.

In accordance with another aspect of the present invention, there is also provided a method for adjusting the dispersion compensation profile of a Fiber Bragg Grating (FBG) provided in an optical grating region of a length of optical fiber and having a characteristic wavelength. The method includes the following steps of:

a) continuously securing the optical grating region along the cantilever portion of an elongated beam member, in a fixed relationship with a neutral axis extending longitudinally through the beam member, preferably in parallel thereto. This may be achieved with glue or an epoxy type of material, as well as soldering of a metalized fiber to the cantilever portion or even a metallic elongated tube perfectly receiving the grating region of the fiber disposed along the cantilever portion and fixed thereto by welding, soldering or crimping or any other means that can transmit a bend from the cantilever portion to the optical grating region, without sliding motion of one relative to the other along the length of the cantilever portion. The grating area may additionally be disposed along a fiber-guiding area provided in the cantilever portion, such as an elongated groove. The beam member is preferably longitudinally inserted in a hollow member having opposed ends.

b) bending the cantilever portion to generate a strain gradient along the FBG, this strain gradient adjusting the dispersion compensation profile and shifting the characteristic wavelength thereof. This is preferably accomplished by:

i) inserting a pair of lateral screws transversally in the hollow member on opposite sides of the cantilever portion of the beam member, opposed threaded cavity being provided transversally through the hollow member and cooperating with the lateral screws;

ii) loosening one of the lateral screws and tightening the other in sequence until a desired bending of the cantilever beam is reached; and

iii) tightening both lateral screws to secure the cantilever beam in the reached desired bending.

c) compressing the cantilever portion longitudinally to generate a linear strain in the FBG, this linear strain rectifying the characteristic wavelength thereof. Preferably, this is accomplished by:

i) exerting a longitudinal pressure on the beam member from one of the opposed ends of the hollow member, by longitudinally inserting a compression screw inside the hollow member, matching threads being provided therein, and rotating this screw; and

ii) longitudinally restraining the beam member at the other one of said opposed ends of the hollow member.

d) athermalising the chromatic dispersion compensator, preferably by providing an athermalising insert inside the hollow member between the compression screw and the beam member, and selecting coefficient of thermal expansion (CTE) of each of the hollow member, compression screw, athermalising insert and beam member so that they together compensate for effects of temperature variations on the characteristic wavelength of the FBG. In the preferred embodiment, the CTE of the athermalising insert is selected so that it is sizeably larger than the CTE of each of the hollow member, compression screw, and beam member.

### EXAMPLE OF REALIZATION

Prototypes of compensators according to the principles stated above were manufactured. A linearly chirped dispersion compensating FBG was used for the characterisation of the compensator. 80 mm long gratings written with a nominal dispersion slope of −840 ps/nm have been used. The compensator has been tested in both dispersion compensation profile adjustability and athermalisation.

The compensator was first tested to determine the maximum range in dispersion level adjustability. The prototype reached an adjustability range from −540 to −1325 ps/nm, and was only limited by the mechanism stroke of this particular prototype. The combination of the two fine screw adjustments at the tip of the cantilever beam enabled a chromatic dispersion adjustment repeatability of 5 ps/nm in the specified range.

Experimental work carried out on other prototypes has shown a maximum adjustability range of −210 to −3360 ps/nm from a nominal value of −840 ps/nm. It should be noted that very large changes in high dispersion levels reduces the usable bandwidth (BW) by the same factor; therefore, the initial BW should be sufficiently wide to accommodate these large changes.

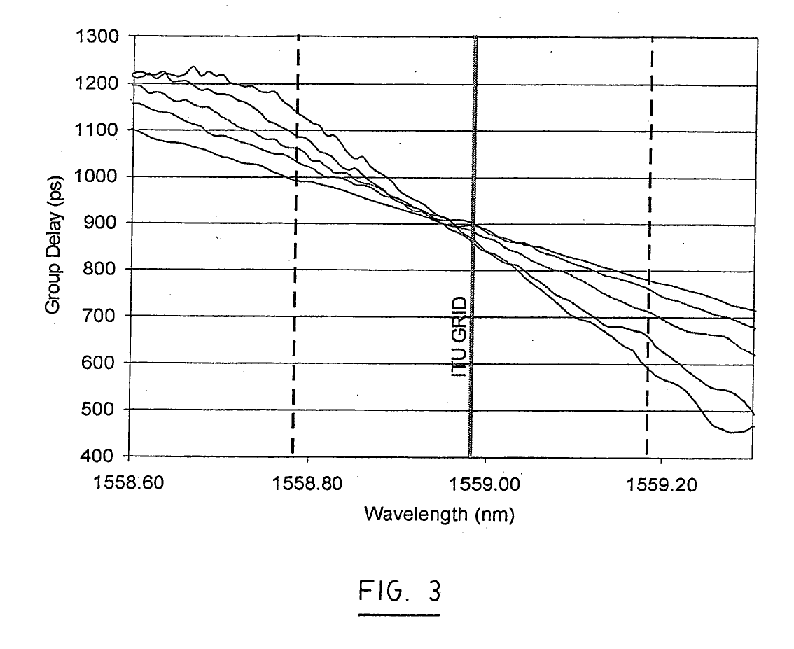

The beam configuration induces a central wavelength shift as the dispersion varies. To compensate for this shift, the highest value of dispersion tested (−1325 ps/nm) was set to the closest 100 GHz ITU grid value (1558.983 nm), and the other dispersion levels were adjusted to the same wavelength. FIG. 3 shows the group delay variation of the device under different set dispersion levels, with a characteristic wavelength adjustment. Dispersion levels are computed as the slope of the linear fit of the group delay within the channel passband.

A correlation has been established between the tuned chromatic dispersion (CD) and the insertion loss reflection bandwidth (BW). As expected, the relation between the two variables is inversely proportional, and is given by:

$$\frac{TunedBW}{InitialBW} = \frac{InitialCD}{TunedCD} \qquad ( 1 )$$

The experimental results have shown a direct correlation to this equation with a maximum error of 1.6% for the full range of adjustability tested. This correlation is very useful to efficiently tune the device to the correct chromatic dispersion level without having to use a CD analyser, a simple optical spectrum analyser being sufficient.

The FBG central wavelength (λ_{c}) and −3 dB bandwidth (BW) of the prototype were measured as a function of temperature, covering the range from 0° C. to +75° C. This allowed for a characterisation of the prototype (at a given BW, chosen approximately at the middle of the adjustability range) within its standard operating temperature range. The optical parameters λ_{c} and BW were monitored using a swept wavelength system (SWS). Measurements were taken after the monitoring of the optical parameters showed complete stabilisation of the device.

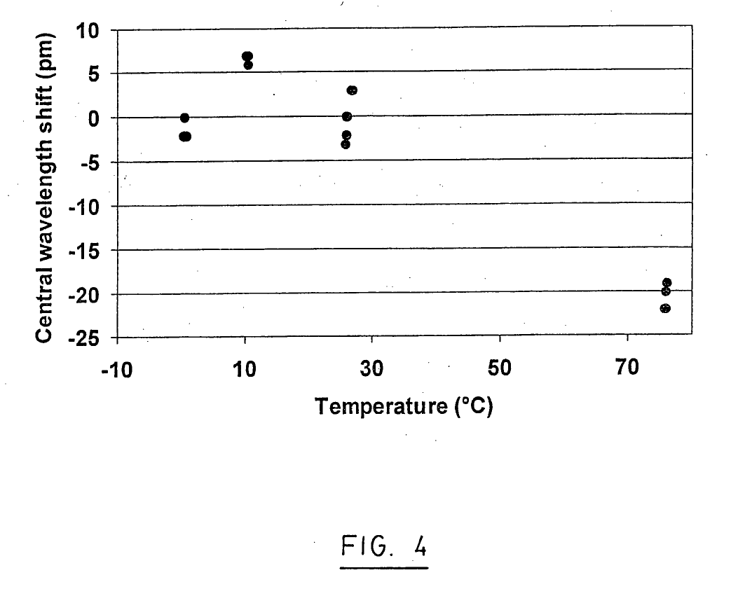

As described above, the central wavelength adjustability is obtained by varying the compression of the beam member; consequently, a minimum compression stress was applied in order to maintain the beam member under compression throughout the temperature range. Initial λ_{c} and BW were measured at 1558.870 nm and 0.705 nm respectively. Those values were used as references for the calculation of the wavelength shift over the considered temperature range. The evolution of the central wavelength shift from 0° C. to +75° C. is presented in FIG. 4. Multiple measurements are shown for each temperature.

The effectiveness of the athermal package has been estimated by calculating the maximum wavelength shift over the operating temperature range, which is below 30 pm. The calculated value corresponds to 0.39 pm/° C. As for the bandwidth, a maximal relative variation of 5% was observed for this prototype.

Results indicate a good dispersion adjustment range and athermalisation throughout the device operating temperatures, thereby demonstrating the feasibility, and therefore the effectiveness of the present invention.

As chromatic dispersion becomes more of an issue with increasing bit-rate communication systems, work is being carried out to facilitate compensation of that dispersion. On the passive front, most of the approaches proposed to date aim to minimise the central wavelength shift associated with the adjustment of the dispersion compensation level, but fail to address the issue of athermalisation, which is required for an FBG based passive components. The present invention discloses an athermal device completely eliminating, rather than minimising the central wavelength shift.

To conclude, experimental results have shown that the dispersion adjustability range of the used prototype is about −540 to −1325 ps/nm, with a repeatability of 5 ps/nm. Athermalisation of the device is also demonstrated, with a total central wavelength shift over the entire operating temperature range of 0.39 pm/° C.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. An adjustable chromatic dispersion compensator, comprising:
a length of optical fiber having an optical grating region;
a Fiber Bragg Grating (FBG) provided in said optical grating region, said FBG having a characteristic wavelength and a dispersion compensation profile;
an elongated beam member having a longitudinal neutral axis and provided with a cantilever portion;
securing means for continuously securing the optical grating region along the cantilever portion in a fixed relationship with said neutral axis;
bending means for bending the cantilever portion to generate a strain gradient along the FBG, said strain gradient adjusting the dispersion compensation profile and shifting the characteristic wavelength thereof; and
compressing means for compressing the cantilever portion longitudinally to generate a linear strain in the FBG, said linear strain rectifying the characteristic wavelength thereof.

2. The adjustable dispersion compensator according to claim 1, wherein the dispersion compensation profile is defined by a linear chirp in the FBG.

3. The adjustable dispersion compensator according to claim 1, wherein the cantilever portion has a constant cross-section perpendicular to the neutral axis along the optical grating region.

4. The adjustable dispersion compensator according to claim 1, wherein the optical grating region is secured to the cantilever portion in parallel to the neutral axis.

5. The adjustable dispersion compensator according to claim 1, wherein the securing means are selected from the group comprising glue, an epoxy type material and a solder.

6. The adjustable dispersion compensator according to claim 1, wherein the securing means comprise a fiber-guiding area receiving the optical grating region of the length of optical fiber therealong.

7. The adjustable dispersion compensator according to claim 1, wherein the cantilever portion has first and second opposed extremities, and the beam member comprises an anchor portion connected to said first extremity of the cantilever portion.

8. The adjustable dispersion compensator according to claim 7, further comprising a hollow member having opposite ends and longitudinally receiving the beam member therein, the anchor portion of the beam member fitting snugly in the hollow member.

9. The adjustable dispersion compensator according to claim 8, wherein the bending means comprise:
a pair of lateral screws projecting transversally in the hollow member on opposite sides of the cantilever portion of the beam member; and
opposed threaded cavities extending transversally through the hollow member cooperating with said lateral screws.

10. The adjustable dispersion compensator according to claim 8, wherein the compression means further comprise:
a pressure exerting mechanism exerting a longitudinal pressure on the beam member from one of the opposite ends of the hollow member; and
a restraining element longitudinally restraining the beam member at the other one of said opposite ends of the hollow member.

11. The adjustable dispersion compensator according to claim 10, wherein the restraining element is defined by a transversal wall integral to said hollow member.

12. The adjustable dispersion compensator according to claim 10, wherein the pressure exerting mechanism comprises:
a compression screw projecting longitudinally inside said hollow member; and
threads extending inside said hollow member and cooperating with the compression screw.

13. The adjustable dispersion compensator according to claim 12, further comprising an athermalising insert extending in said hollow member between the compression screw and the beam member.

14. The adjustable dispersion compensator according to claim 13, wherein the hollow member, compression screw, athermalising insert and beam member each have a coefficient of thermal expansion (CTE) selected so that they together compensate for effects of temperature variations on the characteristic wavelength of the FBG.

15. The adjustable dispersion compensator according to claim 14, wherein the CTE of the athermalising insert is sizeably larger than the CTE of each of the hollow member, compression screw, and beam member.

16. The adjustable dispersion compensator according to claim 15, wherein the hollow member, compression screw, and beam member are each made of invar, and the athermalising insert is made of aluminum.

17. An adjustment assembly for a chromatic dispersion device, said device comprising a length of optical fiber having an optical grating region and a Fiber Bragg Grating (FBG) provided in said optical grating region, said FBG having a characteristic wavelength and a dispersion compensation profile, the adjustment assembly comprising:
an elongated beam member having a longitudinal neutral axis and provided with a cantilever portion;
securing means for continuously securing the optical grating region along the cantilever portion in a fixed relationship with said neutral axis;
bending means for bending the cantilever portion to generate a strain gradient along the FBG, said strain gradient adjusting the dispersion compensation profile and shifting the characteristic wavelength thereof; and
compressing means for compressing the cantilever portion longitudinally to generate a linear strain in the FBG, said linear strain rectifying the characteristic wavelength thereof.

18. The adjustment assembly according to claim 17, wherein the cantilever portion has a constant cross-section perpendicular to the neutral axis along the optical grating region.

19. The adjustment assembly according to claim 17, wherein the optical grating region is secured to the cantilever portion in parallel to the neutral axis.

20. The adjustment assembly according to claim 17, wherein the securing means are selected from the group comprising glue, an epoxy type material and a solder.

21. The adjustment assembly according to claim 1, wherein the securing means comprise a fiber-guiding area receiving the optical grating region of the length of optical fiber therealong.

22. The adjustment assembly according to claim 17, wherein the cantilever portion has first and second opposed extremities, and the beam member comprises an anchor portion connected to said first extremity of the cantilever portion.

23. The adjustment assembly according to claim 22, further comprising a hollow member having opposite ends and longitudinally receiving the beam member therein, the anchor portion of the beam member fitting snugly in the hollow member.

24. The adjustment assembly according to claim 23, wherein the bending means comprise:
a pair of lateral screws projecting transversally in the hollow member on opposite sides of the cantilever portion of the beam member; and
opposite threaded cavities extending transversally through the hollow member cooperating with said lateral screws.

25. The adjustment assembly according to claim 23, wherein the compression means further comprise:
a pressure exerting mechanism exerting a longitudinal pressure on the beam member from one of the opposite ends of the hollow member; and
a restraining element longitudinally restraining the beam member at the other one of said opposite ends of the hollow member.

26. The adjustment assembly according to claim 25, wherein the restraining element is defined by a transversal wall integral to said hollow member.

27. The adjustment assembly according to claim 25, wherein the pressure exerting mechanism comprises:
a compression screw projecting longitudinally inside said hollow member; and
threads extending inside said hollow member and cooperating with the compression screw.

28. The adjustment assembly according to claim 27, further comprising an athermalising insert extending in said hollow member between the compression screw and the beam member.

29. The adjustment assembly according to claim 28, wherein the hollow member, compression screw, athermalising insert and beam member each have a coefficient of thermal expansion (CTE) selected so that they together compensate for effects of temperature variations on the characteristic wavelength of the FBG.

30. The adjustment assembly according to claim 29, wherein the CTE of the athermalising insert is sizeably larger than the CTE of each of the hollow member, compression screw, and beam member.

31. The adjustment assembly according to claim 30, wherein the hollow member, compression screw, and beam member are each made of invar, and the athermalising insert is made of aluminum.

32. A method for adjusting the dispersion compensation profile of a Fiber Bragg Grating (FBG) provided in an optical grating region of a length of optical fiber and having a characteristic wavelength, the method comprising the steps of:
a) continuously securing the optical grating region along the cantilever portion of an elongated beam member, in a fixed relationship with a neutral axis extending longitudinally through said beam member;
b) bending the cantilever portion to generate a strain gradient along the FBG, said strain gradient adjusting the dispersion compensation profile and shifting the characteristic wavelength thereof; and
c) compressing the cantilever portion longitudinally to generate a linear strain in the FBG, said linear strain rectifying the characteristic wavelength thereof.

33. The method according to claim 32, wherein step a) further comprises securing the optical grating region to the cantilever portion in parallel to the neutral axis.

34. The method according to claim 32, wherein step a) further comprises providing securing means selected from the group comprising glue, an epoxy type material and a solder.

35. The method according to claim 32, wherein step a) further comprises disposing the optical grating region of the length of optical fiber along a fiber-guiding area provided in the cantilever portion.

36. The method according to claim 32, comprising an additional step between steps a) and b) of inserting the beam member longitudinally in a hollow member having opposite ends.

37. The method according to claim 36, wherein step b) comprises sub steps of:
i) inserting a pair of lateral screws transversally in the hollow member on opposite sides of the cantilever portion of the beam member, opposite threaded cavity being provided transversally through the hollow member and cooperating with said lateral screws;
ii) loosening one of said lateral screws and tightening the other one of said lateral screws in sequence until a desired bending of the cantilever beam is reached.

38. The method according to claim 37, wherein step b) comprises an additional sub step of:
iii) tightening both lateral screws of said pair to secure the cantilever beam in the reached desired bending.

39. The method according to claim 36, wherein step c) comprises the sub steps of:
i) exerting a longitudinal pressure on the beam member from one of the opposite ends of the hollow member; and
ii) longitudinally restraining the beam member at the other one of said opposite ends of the hollow member.

40. The method according to claim 39, wherein sub step c)i) comprises longitudinally inserting a compression screw projecting inside the hollow member, threads being provided inside said hollow member for cooperating with the compression screw, and rotating said compression screw.

41. The method according to claim 40, further comprising an additional step of athermalising the chromatic dispersion compensator, said additional step comprising providing an athermalising insert inside the hollow member between the compression screw and the beam member.

42. The method according to claim 41, wherein said additional step comprises selecting coefficient of thermal expansion (CTE) of each of the hollow member, compression screw, athermalising insert and beam member so that they together compensate for effects of temperature variations on the characteristic wavelength of the FBG.

43. The method according to claim 42, wherein said additional step comprises further comprises selecting the CTE of the athermalising insert so that it is sizeably larger than the CTE of each of the hollow member, compression screw, and beam member.
